(19) United States
(12) Patent Application Publication
(10) Pub. No.: US 2012/0068931 A1
(43) Pub. Date: Mar. 22, 2012

(54) OPTICAL MOUSE

(75) Inventor: Chi-Chun Chu, Hsinchu City (TW)

(73) Assignee: Sunplus Innovation Technology Inc., Hsinchu (TW)

(21) Appl. No.: 13/232,145

(22) Filed: Sep. 14, 2011

(30) Foreign Application Priority Data
Sep. 16, 2010 (TW) 099131450

(51) Int. Cl. G06F 3/033

(52) U.S. Cl. 345/166

(57) ABSTRACT

An optical mouse is provided with a light guide. The light guide has a collecting surface, a single reflection surface and an exit surface, guiding a light of a light source to a tracking surface through three interface engagements of a refraction, a reflection and a refraction, so as to reduce optical power loss caused by too many interface engagements, and to increase a gazing angle of the light incident to the tracking surface. An array of micro-lenses, as a light diffuser, can be set on the exit surface to improve optical characteristics and distribution of the light incident to the tracking surface.

This application claims the benefit of Taiwan application Serial No. 99131450, filed Sep. 16, 2010, the subject matter of which is incorporated herein by reference.

### FIELD OF THE INVENTION

The present invention relates to an optical mouse, and more particularly, to an optical mouse with a light guide which reduces number of light interfacing along light path, increases gazing angle for light incident toward tracking surface, and improves optical characteristics by array of micro-lenses.

### BACKGROUND OF THE INVENTION

Optical mouse is one of the most popular computer peripherals in modern information society, and techniques to improve performance and to reduce cost of optical mouse have become key demands of modern information developers.

Please refer to FIG. 1 illustrating a cross-section view of a conventional optical mouse 10. When the optical mouse 10 performs pointing function, the optical mouse 10 generates a light incident to a surface 26 (also known as a tracking surface), and senses light reflected by the surface 26, so displacement of the optical mouse 10 can be determined according to differences of reflected light. In this way, when a user moves the optical mouse 10 along the tracking surface 26, the optical mouse 10 can transmits sensed displacement to a computer host (not shown), and the computer host can correspondingly move a cursor on an image shown by a computer monitor, such that the user can control operation of the computer host through a visual man-machine interface implemented by the monitor and the optical mouse.

To implement pointing function of optical mouse, the optical mouse 10 includes a light source 16 (e.g., a light emitting diode, LED), a light guide 20 and a sensor 22; the light source 18 generates light, the light guide 20 guides the light toward the tracking surface 26 by optical reflection and refraction, and the sensor 22 senses light reflected by the tracking surface 26. The light source 16 and the sensor 22 are integrated with a circuit board 18 (a printed circuit board) and are installed on a base 12 of the optical mouse 10 by a clamp 24. The base 12 has an opening 14; through the opening 14, light generated by the light source 16 is guided to the tracking surface 26, and light reflected by the tracking surface 26 is received and focused to the sensor 22.

With a zoomed view, FIG. 1 also illustrates light path guided by the light guide 20. First, light LO generated by the light source 16 is incident to an optical interface 19A of the light guide 20; by refraction of the optical interface 19A, light L1 is formed and is incident to an optical interface 19B. The light L1 is then reflected by the optical interface 19B to form light L2 of first reflection, and the light L2 is incident to an optical interface 19C. The optical interface 19C reflects the light L2 to form light L3 of second reflection. Finally, the light L3 is refracted to be light L4 by the optical interface 19D, so the light L4 is incident to the tracking surface 26.

In other words, in the conventional light guide 20, the light LO provided by the light source 16 is guided to the tracking surface 26 by engaging four optical interfaces 19A to 19D with two reflections and two refractions. Because each optical surface engagement causes optical power loss due to reflection and refraction, optical energy transmission efficiency of the conventional light guide 20 is degraded with low ability to make full use of optical energy.

In addition, because the light path guided by the conventional light guide 20 is much complicated, a gazing angle th0 for the light L4 incident to the tracking surface 26 becomes smaller to be around 20 degrees. For the light L4, most of its power is reflected along an arrow A0; as the gazing angle th0 is smaller, power loss along the tracking surface 26 (i.e., horizontal direction of FIG. 1) becomes greater, and light (perpendicularly) diffused to the sensor 22 to be received/sensed therefore becomes less. As a result, signal to noise ratio of optical signal suffers, and characteristics of pointing function (e.g., precision) degrades.

Nowadays, common optical mice mostly adopt high intensity red light emitting diodes as light sources, as high intensity is demanded due to low optical power transmission efficiency of conventional light guides. According to theory of optical transmission, efficiency of optical power transmission degrades by multiple reflections and refractions of light guide, and therefore high intensity light sources, e.g., red light emitting diodes, are used.

Moreover, the conventional light guide 20 is also sensitive to packaging deviation of the light source 16. In a light source 16 adopting light emitting diode, a die of light emitting diode is covered by a cylindrical package, where a hemisphere dome is formed on one end of the cylindrical package, and two pins (lead-frame) stick out from the other end. To transmit electric energy to the die through the pins, a surface of the die includes bonding pads formed by contacts, and the bonding pads are electrically coupled to the pins by conductive bond wires. As area of each contact is larger, electrical energy can be transmitted to the die more uniformly, and thus light generated by the die becomes more uniform. However, light produced by light emitting diode also suffers from lowered uniformity of light field caused by opaque portion within the package. Since the contacts and the boding pads are opaque, they shadow light emitted by the die and form blind spots of the die in light field distribution of the die; as area of the contacts is larger, influence of the blind spots becomes more obvious. In addition, the bond wires also block before light emitting portion of the LED die, so the light generated by the light emitting portion weakens due to shadowing, and intensity distribution of the light field therefore becomes more non-uniform.

The package of the light source affects uniformity of the light field, too. In the light generated by the die, some portion will form a virtual image of the die due to total reflection of the package, and the virtual image also contributes to non-uniformity of the light field distribution.

Furthermore, locations of the contacts, bond wires and pins vary due to packaging deviation; as a result, different light sources suffer from difference between light field distributions even if the light sources are of identical types and of same manufactory processes. Even a light guide is designed with an attempt to improve light field distribution of a certain type of light source, if the light guide does not have enough tolerant margins for package deviation, effective and full improvement of light field distribution can not be achieved.

In the presently known optical mouse 10, the clamp 24 is used to benefit aligning of the light guide 20 to the light source 16. As improvement of non-uniform light field is concerned, however, effect of such arrangement is not good, and non-uniform light field of the light source 16 will cause non-uniform spots of uncontrollable shapes and sizes in the light L4. Accordingly, uniform images can not be formed on the lit tracking surface 26, and therefore tracking is impacted by lowered linearity of pointing function of the optical mouse 10.

### SUMMARY OF THE INVENTION

An objective of the invention is providing an optical mouse including a base with an opening, a light source installed on the base along an axis for generating an initial light, a light guide installed on the base at a location corresponding to the opening and having a collecting surface, a reflection surface and an exit surface, the collecting surface aligning along a first direction and refracting the initial light to the reflection surface along a straight line to form a reflection light wherein the first direction is perpendicular to the axis and the reflection surface forms a prism surface; the reflection surface reflecting the reflection light to the exit surface along a straight line to form an incident light wherein the exit surface locates on a bottom side of the light guide and parallels the base with a norm direction perpendicular to the axis; and the exit surface refracting the incident light to a tracking surface through the opening; and a sensor receiving the incident light reflected by the tracking surface as a reference for determination of a movement of the optical mouse.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 (prior art) depicts a light path guided by a conventional light guide in an optical mouse;

FIG. 2 depicts a light guide applied to an optical mouse according to an embodiment of the invention;

FIG. 3 depicts views and cross-sections from different angles of the light guide of FIG. 2; and

FIG. 4 depicts light path guided by the light guide of FIG. 2.

### DETAILED DESCRIPTION OF PREFERRED EMBODIMENTS

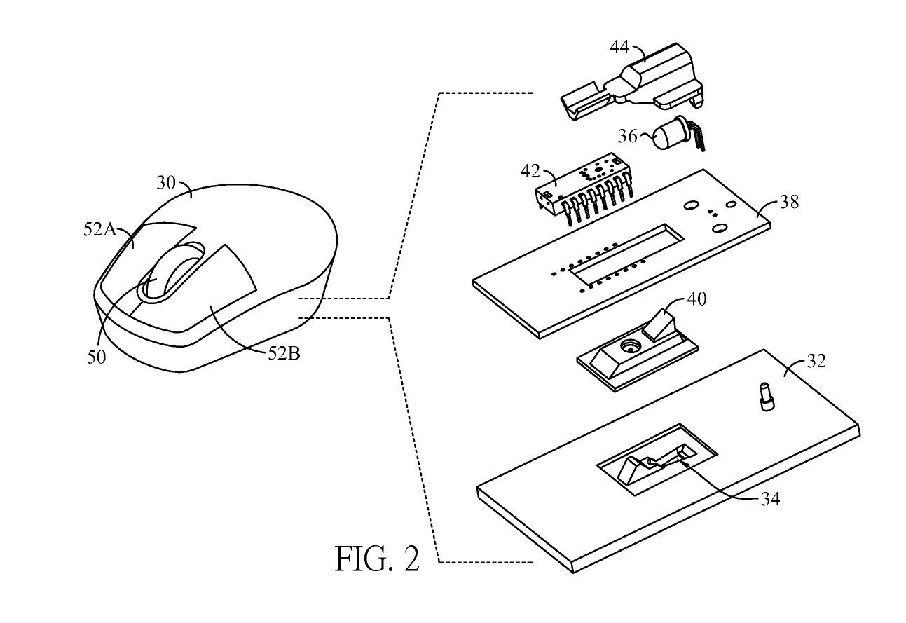

Please refer to FIG. 2 to FIG. 4, FIG. 2 illustrates a light guide 40 applied to an optical mouse 30 according to an embodiment of the invention,

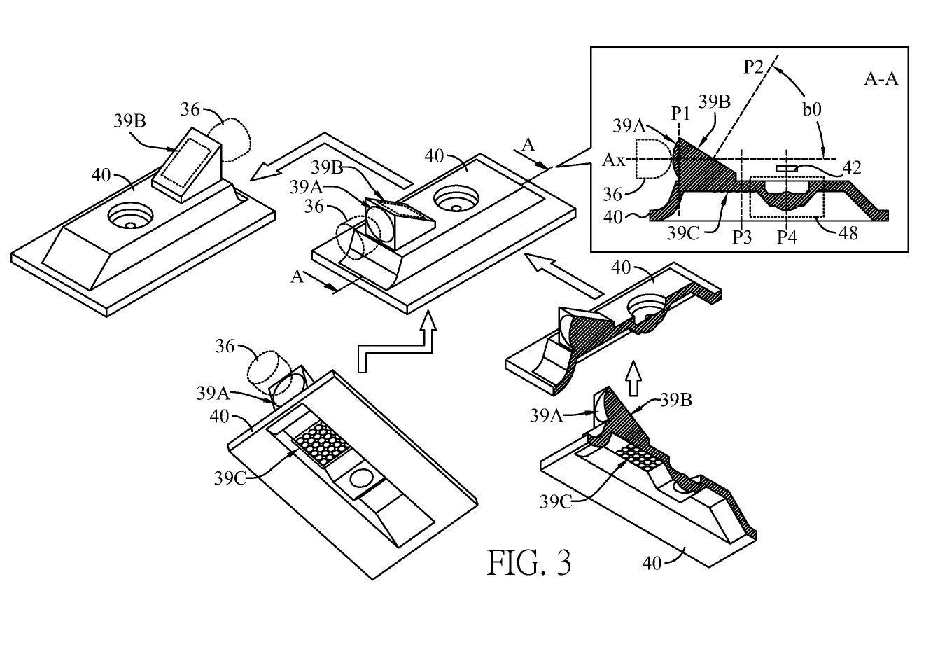

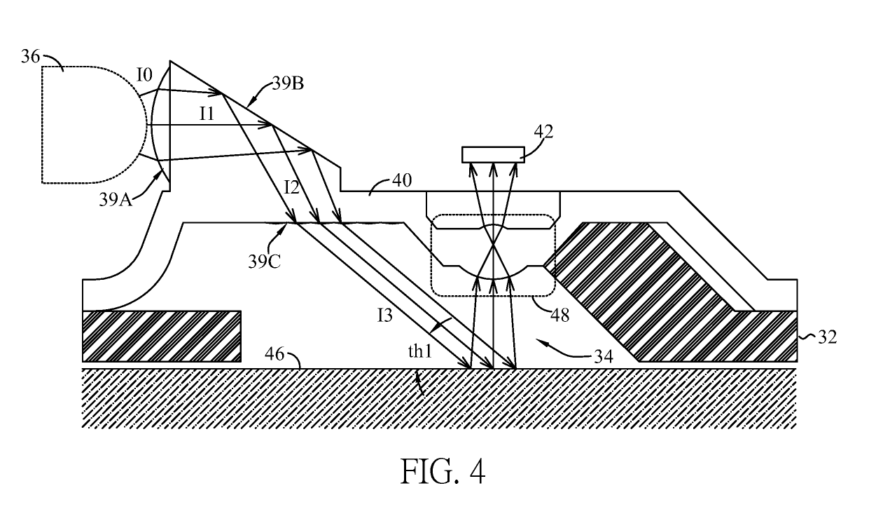

FIG. 3 illustrates a light guide 40 of the invention with views and cross-sections from different view angles, and FIG. 4 illustrates light path of the light guide 40. As shown in FIG. 2, the optical mouse 30 of the invention includes a light source 36, the light guide 40 and a sensor 42 which is in an integrated circuit. The optical mouse 30 can further include a wheel 50, a plurality of buttons 50A and 50B, and/or a wireless module implementing wireless remote control and a power supply module (not shown in FIG. 2).

In the optical mouse 30, the light source transfers electric energy to optical energy to generate light; the light source 36 can be a light emitting diode, like a light emitting diode made of Aluminum Indium Gallium Phosphide or similar materials for emitting red or blue light, such that electric energy can be converted to optical energy with high efficiency. The light guide 40 guides light incident to a tracking surface by optical refraction and reflection, and the sensor 42 receives light reflected from the tracking surface. A light guide dominates performance of an optical mouse, as the light guide works to change light angle of the light source and to homogenize light incident to the tracking surface. A key point of the invention is providing a light guide of improved design, which guides light incident to the tracking surface with better light path, better incident angle and better uniformity, such that detail features (e.g., textures formed by tiny bumps and/or pits) can be projected to the sensor 42 with high accuracy, clearance and precision. In association with the light guide 40, the sensor 42 captures images of the tracking surface with high resolution and high capture rate.

In the embodiment of FIG. 2, the light source 36 and the sensor 42 are integrated with a circuit board 38 (e.g., a printed circuit board), and are fixed to the base 32 of the optical mouse 30 with the light guide 40 by a clamp 44. The clamp 44 fixes an optical axis of the light source 36, so the light source 36 can firmly align to the light guide 40. The base 32 carries aforementioned elements, such that the elements are installed correctly and steadily to maintain good light path; as the base 32 parallels the tracking surface, the optical mouse 30 can be moved smoothly along the tracking surface. The base 32 has an opening 34, and the light guide 40 is installed on the base 32 at a location corresponding to the opening 34; through the opening 34, light generated by the light source 36 is incident to the tracking surface, and light reflected by the tracking surface is received and focused to the sensor 42. The light guide 40 can be made of transparent material, such as transparent plastic material of low cost and high plasticity.

As shown in FIG. 3 and FIG. 4, the light guide 40 has three optical interfaces 39A to 39C as a collecting surface, a reflection surface and an exit surface respectively. The optical interfaces 39A to 39C are molded into a body to maintain firm optical alignments among them. Location of the light source 36 is demonstrated by dash lines in FIG. 3 and FIG. 4, and FIG. 3 also shows a cross-section view along a cross-section line A-A; as shown in the cross-section view, the optical interface 39A (the collecting surface) corresponds to an axis Ax and extends aligning a direction P1 wherein the direction P1 can be perpendicular to the axis Ax. For example, the optical interface 39A can be a lens surface with collimation function, such as a wide aperture non-spherical convex lens, which is symmetric around a symmetric axis of the axis Ax, and is convex outward the surface of the direction P1. The optical interface 39B (the reflection surface) can be a flat plane forming a prism surface with an angle b0 between the axis Ax and a norm direction P2 of the reflection surface; the angle b0 can be set between 0 and 90 degrees. The optical interface 39C (the exit surface) locates on a bottom side of the light guide 40 with a norm direction P3 which can be set to be perpendicular to the base 32, so the optical interface 39C parallels the base 32. As shown in FIG. 3, in an embodiment of the invention, the optical interface 39C can include an array of a plurality of micro-lenses; these micro-lenses form a reflective array of micro-lenses which functions as a light diffuser. For example, the array of micro-lenses can include 6*6 micro-lenses shaped on the optical interface 39C of the light guide 40 by a C-axis machining equipment.

The light guide 40 can also integrate a sensor light collection portion 48. Location of the sensor light collection portion 48 corresponds to that of the sensor 42, so light reflected by the tracking surface can be collected to the sensor 42. The sensor light collection portion 48 can include optical lenses with optical axes along a direction P4, wherein the direction P4 can be parallel to the direction P3 and perpendicular to the axis Ax.

As shown in FIG. 4, the light path guided by the three optical interfaces 39A to 39C of the light guide 40 can be described as follows. The light source 36 generates light l0 (initial light), the light l0 is refracted and focused to be light l1 by the collimation lens of the optical interface 39A, and the light l1 is guided to the optical interface 39B along a straight line to be reflected as light l2 by the prism of the optical interface 39B. The optical interface 39B guides the light l2 to the optical interface 39C along a straight line, so the light l2 is refracted to be light l3 through the optical interface 39C, and the light l3 is guided by the optical interface 39C to propagate through the opening 34 and becomes incident light toward the tracking surface 46. The tracking surface 46 reflects the light l3, such that the reflected light is collected and focused to the sensor 42 by the sensor light collection portion 48. As the tracking surface 46 is illuminated by high-quality incident light provided by the light guide 40 of the invention, detailed structure and texture of the tracking surface 46 can be clearly and precisely projected to the sensor 42. The sensor 42 captures images of the tracking surface 46 with high capture rate (e.g., 1500 images per second), and an optical processing circuit in the integrated circuit where the sensor 42 is embedded compares images captured at different moments to distinguish movement of the images and to evaluate temporal displacement distance and direction of the optical mouse 30, such that pointing function of the optical mouse 30 is implemented.

When the light 10 passes the lens of the optical interface 39A, its beam cross-section is enlarged to correct blind spots due to the light source 36; by reflection and refraction of the optical interface 39B and 39C, the beam cross-section focuses again to compensate optical fringe of the light source 36 and forms incident light of uniform light field propagating to the tracking surface 46. In the array of micro-lenses of the optical interface 39C, each of the micro-lens focuses individually to achieve a total effect analogous to an array of a plurality of virtual light sources for further improvement of light field uniformity of the incident light.

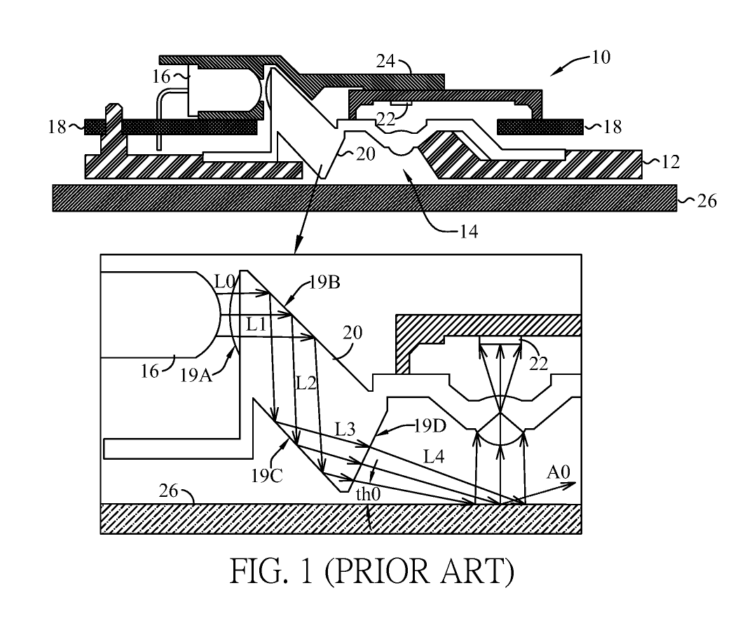

As a comparison between FIG. 1 and FIG. 4 shows, on the guided light path from the light source 16/36 to the tracking surface 26/46, the conventional guided light path (FIG. 1) engages four optical interfaces 19A to 19D with two reflections and two refractions, but the guided light path of the invention (FIG. 4) engages only three optical interfaces 39A to 39C with two refraction and one reflection, so the light guide 40 of the invention can effectively reduce optical power loss of the guided light path. In a typical embodiment of the invention, the light guide 40 increases intensity of the incident light by 10%. By improving the guided light path, the invention can effectively make better use of optical power with higher efficiency, and then reduce light emitting power of the light source 36 to lower power consumption of the light source 36.

In addition, the gazing angle th0 between the incident light L4 and the tracking surface 26 of FIG. 1 can not be greater than 20 degrees, thus amount of light received by the sensor 22 is limited, and performance of tracking is degraded. On the contrary, as shown in FIG. 4, the light guide 40 of the invention effectively increases a gazing angle th1 between the incident light l3 and the tracking surface 46 (the base 32). For example, the gazing angle between the incident light l3 and the base 32 can be between 20 and 40 degrees. Accordingly, greater amount of light is reflected to the sensor 42 to enhance performance of sensing and tracking of the invention.

Moreover, the array of micro-lenses set on the optical interface 39C of the invention diffuses the light l2, so the light l3 has a more uniform light field distribution. Such design can compensate non-uniform emitting light field of the light source 36, and thus sensitivity to packaging deviation of the light source is reduced. If the light field emitted by the light source 36 suffers from non-uniformity due to packaging deviation, the light diffuser implemented on the optical interface 39C can defuse the light field, such that the light field distributes more uniformly, and non-uniform light spots in the incident light l3 can be suppressed/avoided to improve tracking and linearity of pointing function of optical mouse.

To sum up, comparing to the prior art, the light guide in the optical mouse of the invention can reduce power loss of guided light path, increase the gazing angle for light incident to the tracking surface, and enhance tolerance for packaging deviation of light source. Comparing to the prior art, exemplary improvements of the invention can be demonstrated by: increasing the gazing angle for light incident to the tracking surface from conventional 20 degrees to 40 degrees, increasing intensity of the incident light by 10%, improving image lens field by more than 15%, improving surface coverage by more than 35% for red light source and by more than 10% for blue light source. By improvement of guided light path, the invention can make better use of optical power with higher efficiency, and therefore reduce light emitting power of light source to reduce power consumption of light source; for application of wireless optical mouse, the invention can effectively extend operation duration of optical mouse.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical mouse comprising:
a base with an opening;
a light source installed on the base along an axis for generating an initial light;
a light guide installed on the base at a location corresponding to the opening, having a collecting surface, a reflection surface and an exit surface, the collecting surface aligning along a first direction and refracting the initial light to the reflection surface along a straight line to form a reflection light wherein the first direction is perpendicular to the axis and the reflection surface forms a prism surface; the reflection surface reflecting the reflection light to the exit surface along a straight line to form an incident light wherein the exit surface locates on a bottom side of the light guide and parallels the base with a norm direction perpendicular to the axis; and the exit surface refracting the incident light through the opening to a tracking surface; and
a sensor receiving the incident light reflected by the tracking surface as a reference for determination of a movement of the optical mouse.

2. The optical mouse as claimed in claim 1 further comprising:
a light diffuser set on the exit surface.

3. The optical mouse as claimed in claim 2, wherein the light diffuser comprises an array of a plurality of micro-lenses for reducing non-uniform light spots in the incident light.

4. The optical mouse as claimed in claim 1, wherein the base parallels the tracking surface, and a gazing angle between the incident light and the base is between 20 and 40 degrees.

5. The optical mouse as claimed in claim 1, wherein a gazing angle between a norm direction of the reflection surface and the axis is between 0 and 90 degrees.

6. The optical mouse as claimed in claim 1, wherein the initial light forms the incident light merely by the collecting surface, the reflection surface and the exit surface.
